(19) United States
(12) Patent Application Publication
(10) Pub. No.: US 2020/0100639 A1
(43) Pub. Date: Apr. 2, 2020

(54) ROBOTIC VACUUM CLEANERS

(71) Applicant: International Business Machines Corporation, Armonk, NY (US)

(72) Inventors: Lorin Ullmann, Austin, TX (US); Wisam Mohammed, Raleigh, NC (US); Jack P. Yapi, Knightdale, NC (US); Nancy A. Schipon, Apex, NC (US)

(21) Appl. No.: 16/148,434

(22) Filed: Oct. 1, 2018

(51) Int. Cl. A47L 11/40; G05B 19/19; B25J 11/00; B25J 9/16

(52) U.S. Cl. CPC A47L 11/4011; G05B 19/19; A47L 2201/04; B25J 9/1666; G05B 2219/45098; B25J 11/0085

(57) ABSTRACT

Examples of techniques for controlling a plurality of robotic cleaners are disclosed. In one example implementation according to aspects of the present disclosure, a computer-implemented method includes receiving, by a processing system, data about a physical space to be cleaned by at least one of the plurality of robotic cleaners. The method further includes generating, by the processing system, a cleaning plan for the physical space based at least in part on the data about the physical space. The method further includes dispatching, by the processing system, the at least one of the plurality of robotic cleaners within the physical space to clean the physical space based at least in part on the cleaning plan.

### BACKGROUND

The present invention generally relates to cleaning devices, and more specifically, to robotic vacuum cleaners.

A vacuum cleaner uses an air pump to create a partial vacuum to suck up particles (e.g., dirt, debris, and dust) off of surfaces (e.g., the floor, furniture, etc.). The particles are collected in a receptacle knows as a dustbin that can later be emptied to dispose of the particles. Many types of vacuum cleaners exist, such as upright, cyclonic, canister, drum, robotic, etc.

### SUMMARY

Embodiments of the present invention are directed to a computer-implemented method for controlling a plurality of robotic cleaners. A non-limiting example of the computer-implemented method includes receiving, by a processing system, data about a physical space to be cleaned by at least one of the plurality of robotic cleaners. The method further includes generating, by the processing system, a cleaning plan for the physical space based at least in part on the data about the physical space. The method further includes dispatching, by the processing system, the at least one of the plurality of robotic cleaners within the physical space to clean the physical space based at least in part on the cleaning plan.

Embodiments of the present invention are directed to a system. A non-limiting example of the system includes a memory comprising computer readable instructions and a processing device for executing the computer readable instructions for performing a method for controlling a plurality of robotic cleaners.

Embodiments of the invention are directed to a computer program product. A non-limiting example of the computer program product includes a computer readable storage medium having program instructions embodied therewith. The program instructions are executable by a processor to cause the processor to perform a method for controlling a plurality of robotic cleaners.

Additional technical features and benefits are realized through the techniques of the present invention. Embodiments and aspects of the invention are described in detail herein and are considered a part of the claimed subject matter. For a better understanding, refer to the detailed description and to the drawings.

### BRIEF DESCRIPTION OF THE DRAWINGS

The specifics of the exclusive rights described herein are particularly pointed out and distinctly claimed in the claims at the conclusion of the specification. The foregoing and other features and advantages of the embodiments of the invention are apparent from the following detailed description taken in conjunction with the accompanying drawings in which:

FIG. 1 depicts a cloud computing environment according to one or more embodiments described herein;

FIG. 2 depicts abstraction model layers according to one or more embodiments described herein;

FIG. 3 depicts a block diagram of a processing system for implementing the present techniques according to one or more embodiments described herein;

FIG. 4 depicts a block diagram of a processing system for tracking robotic vacuum cleaners and generating a cleaning plan for a physical space to be cleaned by the robotic vacuum cleaners according to one or more embodiments described herein;

FIG. 5 depicts a flow diagram of a method for controlling a plurality of robotic vacuum cleaners according to one or more embodiments described herein; and

FIG. 6 depicts a block diagram of a system for tracking robotic vacuum cleaners and generating a cleaning plan for a physical space to be cleaned by the robotic vacuum cleaners according to one or more embodiments described herein.

The diagrams depicted herein are illustrative. There can be many variations to the diagram or the operations described therein without departing from the spirit of the invention. For instance, the actions can be performed in a differing order or actions can be added, deleted or modified. Also, the term “coupled” and variations thereof describes having a communications path between two elements and does not imply a direct connection between the elements with no intervening elements/connections between them. All of these variations are considered a part of the specification.

In the accompanying figures and following detailed description of the disclosed embodiments, the various elements illustrated in the figures are provided with two or three digit reference numbers. With minor exceptions, the leftmost digit(s) of each reference number correspond to the figure in which its element is first illustrated.

### DETAILED DESCRIPTION

Various embodiments of the invention are described herein with reference to the related drawings. Alternative embodiments of the invention can be devised without departing from the scope of this invention. Various connections and positional relationships (e.g., over, below, adjacent, etc.) are set forth between elements in the following description and in the drawings. These connections and/or positional relationships, unless specified otherwise, can be direct or indirect, and the present invention is not intended to be limiting in this respect. Accordingly, a coupling of entities can refer to either a direct or an indirect coupling, and a positional relationship between entities can be a direct or indirect positional relationship. Moreover, the various tasks and process steps described herein can be incorporated into a more comprehensive procedure or process having additional steps or functionality not described in detail herein.

The following definitions and abbreviations are to be used for the interpretation of the claims and the specification. As used herein, the terms “comprises,” “comprising,” “includes,” “including,” “has,” “having,” “contains” or “containing,” or any other variation thereof, are intended to cover a non-exclusive inclusion. For example, a composition, a mixture, process, method, article, or apparatus that comprises a list of elements is not necessarily limited to only those elements but can include other elements not expressly listed or inherent to such composition, mixture, process, method, article, or apparatus.

Additionally, the term “exemplary” is used herein to mean “serving as an example, instance or illustration.” Any embodiment or design described herein as “exemplary” is not necessarily to be construed as preferred or advantageous over other embodiments or designs. The terms “at least one” and “one or more” may be understood to include any integer number greater than or equal to one, i.e. one, two, three, four, etc. The terms “a plurality” may be understood to include any integer number greater than or equal to two, i.e. two, three, four, five, etc. The term “connection” may include both an indirect “connection” and a direct “connection.”

The terms “about,” “substantially,” “approximately,” and variations thereof, are intended to include the degree of error associated with measurement of the particular quantity based upon the equipment available at the time of filing the application. For example, “about” can include a range of ±8% or 5%, or 2% of a given value.

For the sake of brevity, conventional techniques related to making and using aspects of the invention may or may not be described in detail herein. In particular, various aspects of computing systems and specific computer programs to implement the various technical features described herein are well known. Accordingly, in the interest of brevity, many conventional implementation details are only mentioned briefly herein or are omitted entirely without providing the well-known system and/or process details.

It is to be understood that, although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g., networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported, providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure that includes a network of interconnected nodes.

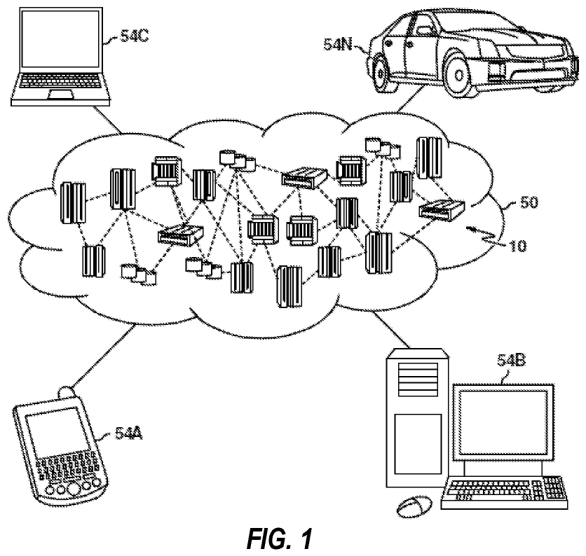

Referring now to FIG. 1, illustrative cloud computing environment 50 is depicted. As shown, cloud computing environment 50 includes one or more cloud computing nodes 10 with which local computing devices used by cloud consumers, such as, for example, personal digital assistant (PDA) or cellular telephone 54A, desktop computer 54B, laptop computer 54C, and/or automobile computer system 54N may communicate. Nodes 10 may communicate with one another. They may be grouped (not shown) physically or virtually, in one or more networks, such as Private, Community, Public, or Hybrid clouds as described hereinabove, or a combination thereof. This allows cloud computing environment 50 to offer infrastructure, platforms and/or software as services for which a cloud consumer does not need to maintain resources on a local computing device. It is understood that the types of computing devices 54A-N shown in FIG. 1 are intended to be illustrative only and that computing nodes 10 and cloud computing environment 50 can communicate with any type of computerized device over any type of network and/or network addressable connection (e.g., using a web browser).

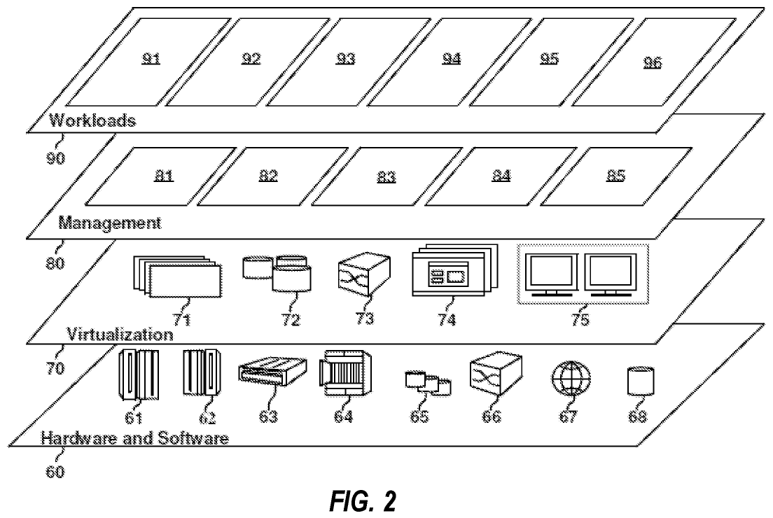

Referring now to FIG. 2, a set of functional abstraction layers provided by cloud computing environment 50 (FIG. 1) is shown. It should be understood in advance that the components, layers, and functions shown in FIG. 2 are intended to be illustrative only and embodiments of the invention are not limited thereto. As depicted, the following layers and corresponding functions are provided:

Hardware and software layer 60 includes hardware and software components. Examples of hardware components include: mainframes 61; RISC (Reduced Instruction Set Computer) architecture based servers 62; servers 63; blade servers 64; storage devices 65; and networks and networking components 66. In some embodiments, software components include network application server software 67 and database software 68.

Virtualization layer 70 provides an abstraction layer from which the following examples of virtual entities may be provided: virtual servers 71; virtual storage 72; virtual networks 73, including virtual private networks; virtual applications and operating systems 74; and virtual clients 75.

In one example, management layer 80 may provide the functions described below. Resource provisioning 81 provides dynamic procurement of computing resources and other resources that are utilized to perform tasks within the cloud computing environment. Metering and Pricing 82 provide cost tracking as resources are utilized within the cloud computing environment, and billing or invoicing for consumption of these resources. In one example, these resources may include application software licenses. Security provides identity verification for cloud consumers and tasks, as well as protection for data and other resources. User portal 83 provides access to the cloud computing environment for consumers and system administrators. Service level management 84 provides cloud computing resource allocation and management such that required service levels are met. Service Level Agreement (SLA) planning and fulfillment 85 provide pre-arrangement for, and procurement of, cloud computing resources for which a future requirement is anticipated in accordance with an SLA.

Workloads layer 90 provides examples of functionality for which the cloud computing environment may be utilized. Examples of workloads and functions which may be provided from this layer include: mapping and navigation 91; software development and lifecycle management 92; virtual classroom education delivery 93; data analytics processing 94; transaction processing 95; and managing robotic vacuum cleaners 96.

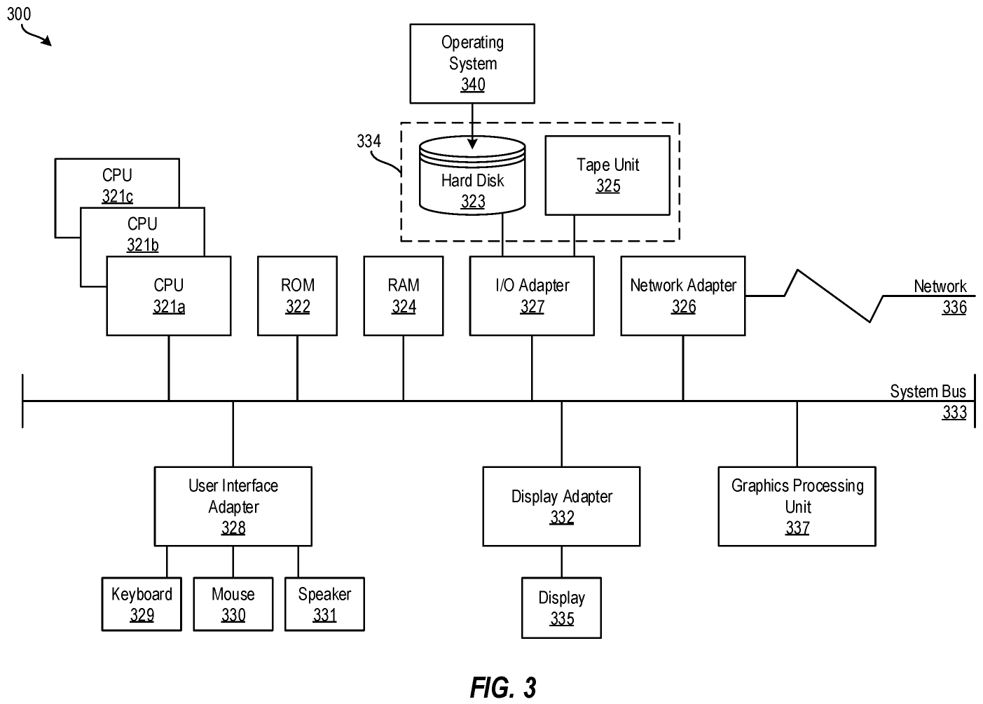

It is understood that the present disclosure is capable of being implemented in conjunction with any other type of computing environment now known or later developed. For example, FIG. 3 depicts a block diagram of a processing system 300 for implementing the techniques described herein. In examples, processing system 300 has one or more central processing units (processors) 321a, 321b, 321c, etc. (collectively or generically referred to as processor(s) 321 and/or as processing device(s)). In aspects of the present disclosure, each processor 321 can include a reduced instruction set computer (RISC) microprocessor. Processors 321 are coupled to system memory (e.g., random access memory (RAM) 324) and various other components via a system bus 333. Read only memory (ROM) 322 is coupled to system bus 333 and may include a basic input/output system (BIOS), which controls certain basic functions of processing system 300.

Further depicted are an input/output (I/O) adapter 327 and a network adapter 326 coupled to system bus 333. I/O adapter 327 may be a small computer system interface (SCSI) adapter that communicates with a hard disk 323 and/or a tape storage drive 325 or any other similar component. I/O adapter 327, hard disk 323, and tape storage device 325 are collectively referred to herein as mass storage 334. Operating system 340 for execution on processing system 300 may be stored in mass storage 334. The network adapter 326 interconnects system bus 333 with an outside network 336 enabling processing system 300 to communicate with other such systems.

A display (e.g., a display monitor) 335 is connected to system bus 333 by display adaptor 332, which may include a graphics adapter to improve the performance of graphics intensive applications and a video controller. In one aspect of the present disclosure, adapters 326, 327, and/or 232 may be connected to one or more I/O busses that are connected to system bus 333 via an intermediate bus bridge (not shown). Suitable I/O buses for connecting peripheral devices such as hard disk controllers, network adapters, and graphics adapters typically include common protocols, such as the Peripheral Component Interconnect (PCI). Additional input/output devices are shown as connected to system bus 333 via user interface adapter 328 and display adapter 332. A keyboard 329, mouse 330, and speaker 331 may be interconnected to system bus 333 via user interface adapter 328, which may include, for example, a Super I/O chip integrating multiple device adapters into a single integrated circuit.

In some aspects of the present disclosure, processing system 300 includes a graphics processing unit 337. Graphics processing unit 337 is a specialized electronic circuit designed to manipulate and alter memory to accelerate the creation of images in a frame buffer intended for output to a display. In general, graphics processing unit 337 is very efficient at manipulating computer graphics and image processing, and has a highly parallel structure that makes it more effective than general-purpose CPUs for algorithms where processing of large blocks of data is done in parallel.

Thus, as configured herein, processing system 300 includes processing capability in the form of processors 321, storage capability including system memory (e.g., RAM 324), and mass storage 334, input means such as keyboard 329 and mouse 330, and output capability including speaker 331 and display 335. In some aspects of the present disclosure, a portion of system memory (e.g., RAM 324) and mass storage 334 collectively store an operating system such as the AIX® operating system from IBM Corporation to coordinate the functions of the various components shown in processing system 300.

Turning now to an overview of technologies that are more specifically relevant to aspects of the invention, vacuum cleaners have long been used to sweep floors and clean other surfaces. A manually operated vacuum cleaner relies on a human user to operate the vacuum cleaner. A robotic vacuum cleaner can have autonomous functionality to enable the robotic vacuum cleaner to move autonomously through a physical space while sucking up particles and collecting them in its dustbin. However, conventional robotic vacuum cleaners have only limited capabilities of understanding their surroundings (e.g., stairs, lack of knowledge of a floor plan, etc.). As a result, a conventional robotic vacuum cleaner might waste energy cleaning a space that does not need to be cleaned or fail to clean an area within the physical space that needs to be cleaned.

Turning now to an overview of the aspects of the invention, one or more embodiments of the invention address the above-described shortcomings of the prior art by providing a robotic vacuum cleaning system that uses multiple robotic vacuum cleaners to inspect and clean a physical space that can include multiple stories/levels. The vacuum cleaning system creates a cleaning plan, for example, using a “scout” robotic device, which can be a robotic vacuum cleaner or another robotic device. Using the plan, the vacuum cleaning system described herein can dispatch robotic vacuum cleaners throughout a physical space, including to different stories/levels, to clean spaces based on factors such as the space's usage, occupancy, weather conditions, and the like.

Unlike conventional robotic vacuum cleaners, the technical solutions described herein provide an environment that uses sensors within a physical space and data about the space to enable robotic vacuum cleaners to clean a space efficiently. For example, the techniques described herein enable a robotic vacuum cleaner to use sensors that allow it to know information about traffic in the space, information about weather, information about the usage of a room, and how multiple robotic vacuum cleaners can be used together to clean a space. By using such data, the robotic cleaning techniques described herein represent improvements to existing robotic cleaning technology. For example, by utilizing data about a physical space, robotic vacuum cleaners can work together to clean an area quickly and efficiently based on occupancy, priority, cleanliness, weather and other factors.

The above-described aspects of the invention address the shortcomings of the prior art by providing a number of advantages over conventional robotic vacuum cleaner technology. For example, the present techniques decrease cleaning time and decrease battery usage (i.e., power consumption) while accurately cleaning physical spaces based on usage, weather, etc. Moreover, the present techniques create plans, schedules, and priority for cleaning a space to enable the use of multiple robotic vacuum cleaners to work together. Additionally, robotic vacuum cleaners can be equipped with flight capabilities (referred to as “drone robotic vacuum cleaners”) to enable the robotic vacuum cleaners to clean different floors/levels of a structure. These and other advantages will be apparent from the following description.

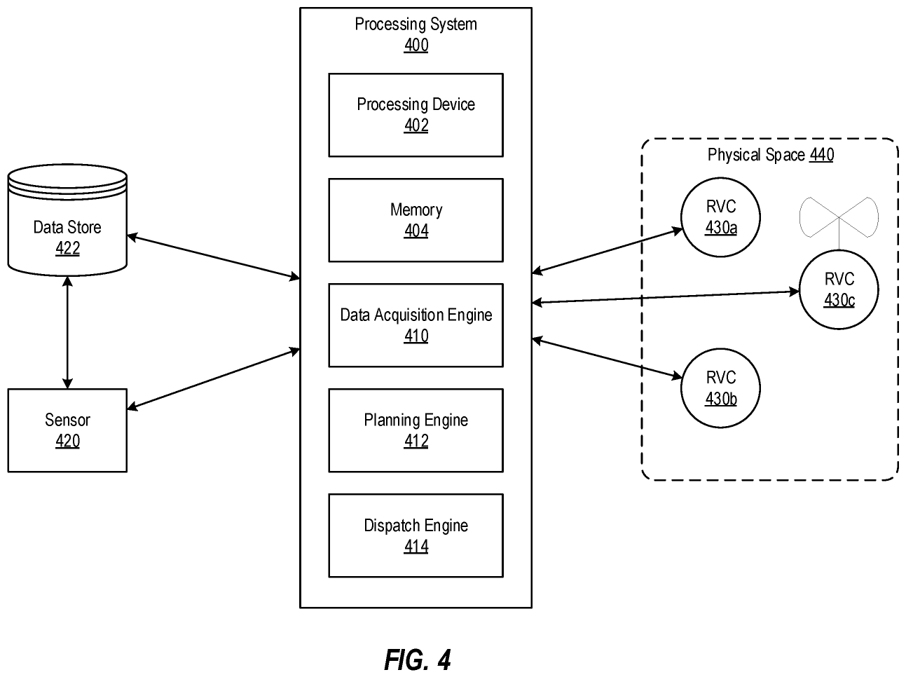

Turning now to a more detailed description of aspects of the present invention, FIG. 4 depicts a block diagram of a processing system 400 for tracking robotic vacuum cleaners 430a, 430b, 430c and generating a cleaning plan for a physical space 440 to be cleaned by the robotic vacuum cleaners 430a, 430b, 430c according to aspects of the present disclosure. The robotic vacuum cleaners 430a, 430b, 430c are collectively referred to as “robotic vacuum cleaners 430” or “RVC 430” and the processing system 400 is also referred to as a “robotic vacuum cleaner control system.” The processing system 400 includes a processing device 402, a memory 404, a data acquisition engine 410, a planning engine 412, and a dispatch engine 414.

The various components, modules, engines, etc. described regarding FIG. 4 can be implemented as instructions stored on a computer-readable storage medium, as hardware modules, as special-purpose hardware (e.g., application specific hardware, application specific integrated circuits (ASICs), application specific special processors (ASSPs), field programmable gate arrays (FPGAs), as embedded controllers, hardwired circuitry, etc.), or as some combination or combinations of these. According to aspects of the present disclosure, the engine(s) described herein can be a combination of hardware and programming. The programming can be processor executable instructions stored on a tangible memory, and the hardware can include the processing device 402 for executing those instructions. Thus a system memory (e.g., memory 404) can store program instructions that when executed by the processing device 402 implement the engines described herein. Other engines can also be utilized to include other features and functionality described in other examples herein.

The data acquisition engine 410 acquires and/or received data from sensors (e.g., sensor 420) and/or data stores (e.g., data store 422). The sensor 420 can be one or more sensor and can be any suitable type of sensor for sensing information about a physical space, such as temperature, occupancy, usage, light/noise, and other factors. In some examples, the sensor 420 collects data from security cameras, lawnmowers, cars, weather systems, automation devices, thermostats, fire and security devices, door sensors, locks, and the like. Other sensors are also possible and within the scope of the present disclosure. The data acquisition engine 410 can save data collected by the sensor 420 to the data store 422 for future reference and historical tracking, for example.

In some examples, one or more of the robotic vacuum cleaners 430 can be equipped with a sensor or sensors to detect information about a physical space that the robotic vacuum cleaners 430 occupy. For example, one or more of the robotic vacuum cleaners 430 can be equipped with sensors to sense whether a physical area is occupied, whether the space is clean or dirty, etc. According to one or more embodiments described herein, one of the robotic vacuum cleaners 430 (e.g., the robotic vacuum cleaner 430a) can be designated as a “master” robotic vacuum cleaner and one or more of the other robotic vacuum cleaners 430 (e.g., the robotic vacuum cleaners 430b, 430c) can be designated as a “slave” robotic vacuum cleaner. The master can inspect and/or control the slaves. For example, the master can inspect a physical space and communicate cleaning plans to the slaves to cause the slaves to implement the cleaning plan.

According to one or more embodiments described herein, the sensor 420 can be an Internet of Things device. The term Internet of Things (IoT) device is used herein to refer to any device (e.g., an appliance, a sensor, etc.) that has an addressable interface (e.g., an Internet protocol (IP) address, a Bluetooth identifier (ID), a near-field communication (NFC) ID, etc.) and can transmit information to one or more other objects over a wired or wireless connection. An IoT device may have a passive communication interface, such as a quick response (QR) code, a radio-frequency identification (RFID) tag, an NFC tag, or the like, and/or an active communication interface, such as a modem, a transceiver, a transmitter-receiver, or the like. An IoT device can have a particular set of attributes (e.g., a device state or status, such as whether the IoT object is on or off, open or closed, idle or active, available for task execution or busy, and so on, a cooling or heating function, an environmental monitoring or recording function, a light-emitting function, a sound-emitting function, etc.) that can be embedded in and/or controlled/monitored by a central processing unit (CPU), microprocessor, ASIC, or the like, and configured for connection to an IoT network such as a local ad-hoc network or the Internet. For example, IoT objects may include, but are not limited to, refrigerators, toasters, ovens, microwaves, freezers, dishwashers, dishes, hand tools, clothes washers, clothes dryers, furnaces, heating, ventilation, air conditioning & refrigeration (HVACR) systems, air conditioners, thermostats, fire alarm & protection system, fire, smoke & CO detectors, access/video security system, elevator and escalator systems, burner and boiler controls, building management controls, televisions, light fixtures, vacuum cleaners, robotic vacuum cleaners, pet collars, sprinklers, electricity meters, gas meters, etc., so long as the devices are equipped with an addressable communications interface for communicating with the IoT network. IoT devices may also include cell phones, desktop computers, laptop computers, tablet computers, personal digital assistants (PDAs), etc. Accordingly, the IoT network can include a combination of “legacy” Internet-accessible devices (e.g., laptop or desktop computers, cell phones, etc.) in addition to devices that do not typically have Internet-connectivity (e.g., dishwashers, speakers, vacuum cleaners, etc.).

In the example of FIG. 4, three robotic vacuum cleaners (RVC) 430a, 430b, 430c are illustrated. It should be appreciated that fewer or greater numbers of robotic vacuum cleaners can be utilized in accordance with the description provided. The robotic vacuum cleaners 430 are configured to communicate with the processing system 400 using any suitable communication protocol such as Ethernet, WiFi, Bluetooth, Near Field Communication, radio frequency, infrared, etc. Also, one or more of the robotic vacuum cleaners 430 can be an Internet of Things device. One or more of the robotic vacuum cleaners 430 can be configured to perform cleaning tasks (e.g., vacuuming, mopping, etc.) in a cleaning mode and to perform scouting/inspection tasks in a scout mode. For example, the robotic vacuum cleaner 430c can be configured as a drone to fly within a physical space to inspect the physical space, such as using an onboard camera or another sensor(s), while operating in a scout mode. The robotic vacuum cleaner 430c can also operate in a cleaning mode to clean the physical space.

In some examples, the data acquisition engine 410 can collect the following information, via the sensor 420 and/or the data store 422: a number of people per room (detectable, for example, by camera data, data received from devices associated with the users, data received from electronic locks or other access control devices, etc.); whether a room is sensed to be dirty (e.g. dirty mats, whether windows/doors were opened, etc.); weather data (e.g., if raining, mud is anticipated; if spring, heavy pollen is anticipated); whether animals are in a physical space, and which areas the animals occupy (e.g., an electronic tag on an animal/pet collar can be tracked to determine which areas need to be cleaned based on the areas of the physical space that the animal occupied); when the area was last cleaned; when the area was last inspected; information about street cleaning or parking lot cleaning; etc.

According to one or more embodiments described herein, whether windows/doors were open can be detected using IoT devices or sensors that can be connected to windows and/or doors to detect if the window/door is open (or has been opened). These IoT devices or sensors can be smart locks, motion sensors, alarm sensors associated with a security system, and the like. An open window can be indicative of an increased level of dirtiness in a room compared to a room without an open window. An opened door can be indicative of the presence of an individual(s) in a room, which can also indicate an increased level of dirtiness in the room compared to a room without occupancy.

According to one or more embodiments described herein, an electronic tag on an animal/pet collar can send data to the processing system 400 to indicate where the animal/pet moved throughout the physical space 440. For example, the collar can connect to the processing system 400 by any suitable wireless and/or wired communication protocol. The data received from the animal/pet collar indicates information about where the animal/pet was located in the physical space 440 (e.g., the animal/pet was in a bedroom, a living room, and a kitchen of the physical space 440), and for how long. This can enable the planning engine 412 to generate a cleaning plan based on areas that the animal/pet occupied, because these areas may be dirtier than areas that the animal/pet did not occupy.

The data store 422 can store data collected from stationary sensors (e.g., a motion sensor affixed in a room, an alarm system sensor, etc.) and from moveable sensors (e.g., a sensor on one of the robotic vacuum cleaners 430, a sensors attached to a pet's collar, etc.). The sensors can be provided by third-parties and can be configured to send and/or receive data. For example, a smart door lock can be configured to transmit data about a status of a door (e.g., open, closed, locked, unlocked, etc.) to the data store 422, to the data acquisition engine 410, etc. Sensors can communicate with the data store 422, the processing system 400, the data acquisition engine 410, etc., using any suitable wireless and/or wired communication protocol (e.g., Bluetooth, radio frequency, WiFi, near field communications, etc.). In this way, the processing system 400 can connect to other systems, such as security systems, camera systems, smart home systems, etc. Some data can be stored locally to the physical space 440 while other data can be stored in a remote location, such as cloud computing environment. The data store 422 can be any suitable data base, data storage system, cloud storage, and the like, and the processing system 400 can connect to the data store 422 via any suitable wireless and/or wired communication protocol. In some examples, IoT devices or sensors are accessed directly or in a private network to receive their data. For example, smart door locks can provide an application program interface (API) that can be used to detect an open/closed door and provide this data to the data store 422.

In some examples, the data store 422 can collect data from a security monitoring system, the data including motion data, camera data, temperature data, window/door opening data, etc. The security system can be implemented in a cloud environment (e.g., the cloud environment 50) on a local data storage (e.g., the data store 422), and the like. The sensor 420 can also be used to gather weather data such as from a weather appliance at a house or building and/or, the data acquisition engine 410 can acquire weather data such as from a weather forecasting company. The sensor 420 can be, according to one or more examples, associated with an animal/pet, such as by being attached to the pet's collar. In such cases, the sensor can indicate dirtiness based on where the pet is (or has been) within the physical space 440.

In another example different types of people may occupy the physical space 440. For example, a first person and a second person may both occupy the physical space 440. For this example, it is assumed that the first person causes the physical space 440 to be dirtier than the second person. Data can be collected using cellphones or other devices associated with the first person and the second person to determine when each of these individuals occupies the physical space. For example, a cellphone for the first person may provide the location of the first person within the physical space 440, such as by GPS data, as an indication of areas that may be dirty (i.e., the areas the first person occupied may be flagged as dirty). Similarly, a cellphone for the second person may provide the location of the second person within the physical space 440, such as by GPS data. In this example, areas of the physical space 440 occupied by the first person may be flagged as needing to be cleaned, while areas occupied by the second person may or may not be flagged as needing to be cleaned. Window sensors can also be used to determine a level of dirtiness of an area. For example, an open (or previously opened) window can indicate potential dirtiness of an area. In some cases, one or more of the vacuum cleaning robots 420 can be equipped with sensors to detect a level of dirtiness. For example, one of the vacuum cleaning robots 420 can be equipped with a camera or other similar sensor to collect data about dirt/debris on a floor or other area to be cleaned (e.g., dirt can be detected on a floor by the camera). The data store 422 can also track an amount of time an area is used, how many times people entered/left the area, how many people were in the area, etc., to determine a level of dirtiness.

The planning engine 412 uses the data collected by the sensor 420 and/or received from the data store 422 to generate a cleaning plan for a physical space based at least in part on the data collected about the physical space by the sensor 420. The plan can include a total dirt score based on how clean or dirty an area is, a room cleaning priority (e.g., clean higher traffic areas such as hallways before cleaning lower traffic areas such as seldom used conference rooms), which areas need to be inspected to determine whether they need to be cleaned, etc. These determinations can be made using the data collected by the sensor 420 and/or stored in the data store 422. For example, if a weather forecast indicates snowy conditions, the cleaning plan may indicate to clean higher traffic areas like hallways several times throughout the day to vacuum up salt/sand that may be applied to outside sidewalks that is tracked inside. Similarly, the cleaning plan may indicate not to clean a particular area if it is determined that the area is not used. For example, if a calendar indicates that no meeting was scheduled on a particular day for a conference room, then the conference room may not be included to be cleaned on the cleaning plan.

The cleaning plan can be based on user-defined preferences, such as a cleaning frequency (e.g., clean each area/room of a physical space at least once per week), dirtiness criteria (e.g., clean an area/room of a physical place if the dirt score exceeds a threshold defined by the user), a priority (e.g., clean an entry way of the physical space first, clean areas with a higher dirt score before cleaning areas with a lower dirt score, etc.).

The planning engine 412 can calculate a total dirt score for areas of the physical space 440 using the data stored in the data store 422 and/or data received from IoT devices and sensors located throughout or associated with the physical space 440. The dirt score can be calculated for individual areas of the physical space 440 and/or for the entire physical space 440. An example of a total dirt score for a house/residence is calculated as a number of “weather dirty days” divided by a “house dirty score calculation” according to the following table.

| House Dirty Score | | |
|---|---|---|
| Calculation (DSLC) | Value | Whole House Dirty Score |
| Number of days since last | 14 | |
| cleaning (DSLC) | | |
| Weather Dirty days Severity | 8 | 8/14 |
| (dusty, pollen, wind speed, | | |
| rain) | | |
| Number of People in house | 10 | 10/14 |
| (could be changed to hours) | | |
| Number of Animals entered | 2 | 2/14 |
| house | | |
| Dirty doormats | 3 | |
| Windows or doors remain | yes/no | |
| Open for more than 2 | | |
| minutes | | |
| Small kids in house | yes/no | |

TOTAL Dirty Score
0-1 do nothing (no cleaning, no scout robot sent to check rooms)
2-5 = send scout robot to check for dirty rooms
Over 6 = cleaning is needed

The “weather dirty days” indicate days with weather that may increase dirtiness within the physical space 440 (e.g., snow days, days with higher than average pollen count, windy days, rainy days, etc.). The “house dirty score calculation” is calculated based on various values assigned to categories such as a number of days since last cleaning, number of people in the house, number of pets/animals in the house, dirty doormat sensors, whether windows or doors remain open for more than a certain period (e.g., 2 minutes, 5 minutes, etc.), whether particular occupants are dirtier than average (e.g., a young child), and the like. The total dirt score is used to generate the cleaning plan. For example, a total dirt score of 0-1 indicates that no cleaning needs to be performed; a total dirt score of 2-5 indicates that a scout robot should be dispatched to check for dirty areas/rooms; and a total dirt score of 6+ indicates that cleaning is needed.

In some examples, the planning engine 412 can calculate a quick trigger dirt score, which can result in immediate cleaning of the physical space 440. For example, if it is determined that a particular event is true, a robotic vacuum cleaner is immediately dispatched to clean an area of the physical space 440. As one such example, if it is determined that an animal/pet leaves an area of the physical space 440 for more than two minutes, one of the robotic vacuum cleaners 430 is dispatched to clean that area. As another example, if it is determined that a window or exterior door of an area of the physical space 440 is left open for more than five minutes, one of the robotic vacuum cleaners 430 is dispatched to clean that area, such as after the window/door is closed.

The dispatch engine 414 dispatches robots within the physical space to clean the physical space based at least in part on the cleaning plan. For example, the dispatch engine 414 can dispatch robotic vacuum cleaners 430a, 430b to clean the first floor of a physical space while dispatching robotic vacuum cleaner 430c to scout/inspect the second floor of the physical space. The cleaning plan can provide information to the robotic vacuum cleaners 430 regarding which rooms/areas to clean (e.g., a heavily used hallway, a room that had a scheduled meeting, a guest bedroom that was occupied, etc.) and which to skip (e.g., an unused office, an unused bedroom, etc.).

It should be appreciated that the cleaning plan can indicate which of the robotic vacuum cleaners 430a-430c should clean/scout which areas of a physical space. This enables the robotic vacuum cleaners 430 to operate efficiently by working together. This avoids skipping areas and/or cleaning one area more than once.

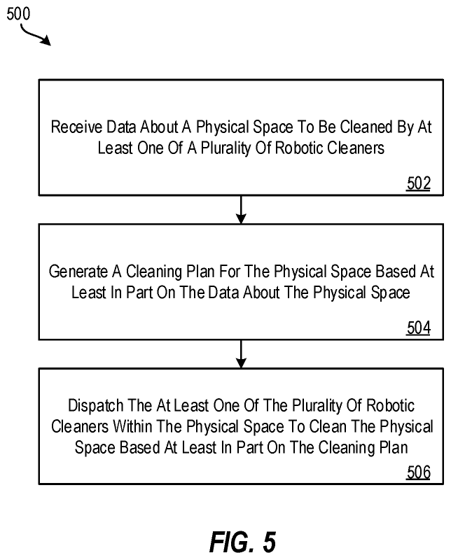

FIG. 5 depicts a flow diagram of a method 500 for controlling a plurality of robotic vacuum cleaners according to one or more embodiments described herein. The method 500 can be implemented using any suitable processing system and/or processing device, such as the cloud environment 50, the processing system 300, the processing system 400, and the like and/or components thereof.

At block 502, the data acquisition engine 410 (or a suitable processing device) receives data about a physical space to be cleaned by at least one of the plurality of robotic vacuum cleaners. The data about the physical space can include inside data and outside data. The inside data relates to an area within the physical space, such as inside temperature, whether music is playing, whether an alarm system is armed/disarmed, whether proximity sensors detect the presence of individuals or pets, calendar data, whether lights are turned off/on and which are off/on, etc. The outside data relates to an area outside of the physical space, such as weather conditions, outdoor temperature, traffic conditions, etc.

At block 504, the planning engine 412 (or a suitable processing device) generates a cleaning plan for the physical space based at least in part on the data about the physical space.

At block 506, the dispatching engine 414 (or a suitable processing device) dispatches the at least one of the plurality of robotic vacuum cleaners within the physical space to clean the physical space based at least in part on the cleaning plan.

Additional processes also may be included. For example, according to one or more embodiments described herein, the physical space can be a multi-level (i.e., multi-story) building or structure. In such examples, the physical space can include a first level and a second level, and dispatching the at least one of the plurality of robotic vacuum cleaners includes dispatching a first subset of the plurality of robotic vacuum cleaners to the first level of the physical space and dispatching a second subset of the plurality of robotic vacuum cleaners to the second level of the physical space. According to one or more embodiments described herein, dispatching the at least one of the plurality of robotic vacuum cleaners to the second level includes causing the at least one of the plurality of robotic vacuum cleaners to travel from the first level to the second level using an elevator, an escalator, etc. According to other embodiments described herein, dispatching the at least one of the plurality of robotic vacuum cleaners to the second level includes causing a flying drone to transport the at least one of the plurality of robotic vacuum cleaners from the first level to the second level. The flying drone can be a separate device that couples to the robotic vacuum cleaner to pick up the robotic vacuum cleaner and move it, or flying drone capabilities can be integrated into a robotic vacuum cleaner.

According to one or more embodiments described herein, the dispatching engine 414 dispatches the at least one of the plurality of robotic vacuum cleaners within the physical space as a scout robot to observe the physical space without cleaning the physical space. The scout robot can operate in a scout mode and a cleaning mode. For example, the scout robot operates in a scout mode responsive to being dispatched to observe the physical space, and the scout robot operates in a cleaning mode responsive to being dispatched to clean the physical space.

In some examples, at least one of the plurality of robotic vacuum cleaners is configured to communicate with at least one other of the plurality of robotic vacuum cleaners, such as by wired and/or wireless communication techniques (e.g., via a Bluetooth connection, via a WiFi connection, via a near field communication (NFC) connection, via a radio frequency connection, etc.). Further, in some examples, at least one of the plurality of robotic vacuum cleaners is configured to communicate with a robotic vacuum cleaner control system.

It should be understood that the process depicted in FIG. 5 represents an illustration, and that other processes may be added or existing processes may be removed, modified, or rearranged without departing from the scope and spirit of the present disclosure.

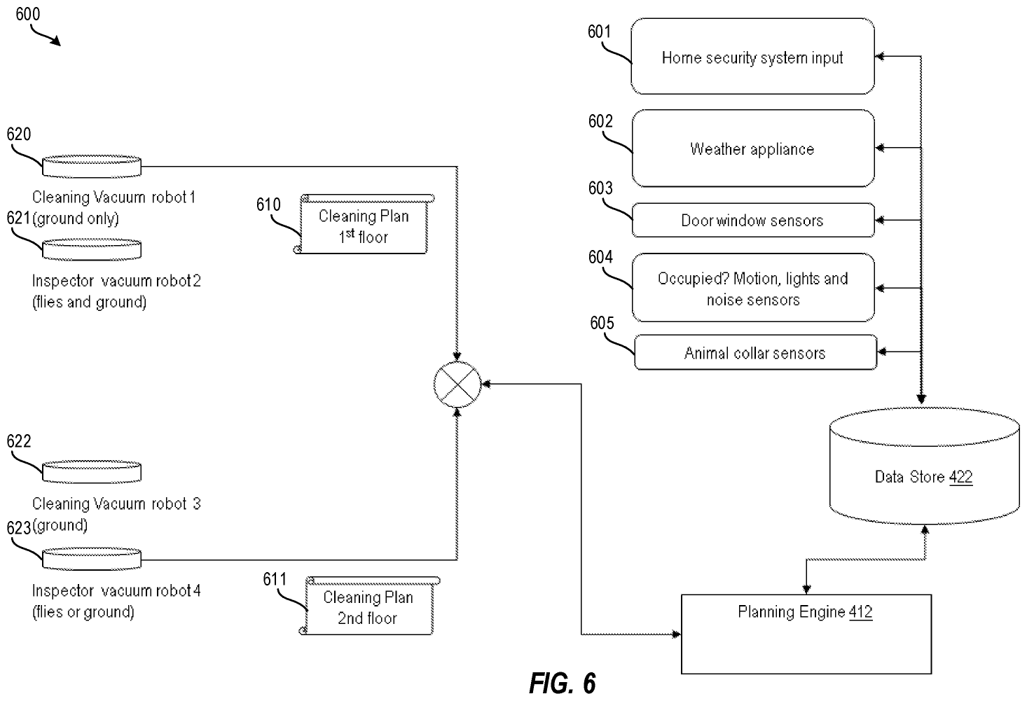

FIG. 6 depicts a block diagram of a system 600 for tracking robotic vacuum cleaners and generating a cleaning plan for a physical space to be cleaned by the robotic vacuum cleaners according to one or more embodiments described herein. The system 600 utilizes the data store 422 and the planning engine 412 of FIG. 4 to generate cleaning plans.

In particular, the data store 422 receives data from various sources, such as home security system input 601, a weather appliance 602, door and window sensors 603, motion sensors 604, animal collar sensors 605, and the like. The planning engine 412 utilizes the data stored in the data store 422 to generate cleaning plans 610, 611 for the first floor and second floor respectively of a physical space. The cleaning plan defines how robotic vacuum cleaners 620, 621, 622, 623 clean the physical space. One or more of the robotic vacuum cleaners 620-623 can be configured as a scout robot to inspect an area, and one or more of the robotic vacuum cleaners 620-623 can be configured with flight capabilities to enable that robotic vacuum cleaner to fly from one area to another area (e.g., to fly from the first floor to the second floor).

In this example, the physical space includes a first floor (i.e., level or story) and a second floor. The robotic vacuum cleaners 620, 621 are responsible for implementing the first floor cleaning plan 610 to clean the first floor and the robotic vacuum cleaners 622, 623 are responsible for implementing the second floor cleaning plan 611 to clean the second floor. In some examples, one or more of the robotic vacuum cleaners 620, 621, 622, 623 can be dispatched, such as by the dispatch engine 414, to another floor to implement that floors cleaning plan. For example, the dispatch engine 414 can dispatch the robotic vacuum cleaner 621 to the second floor to assist the robotic vacuum cleaners 622, 623. This may occur where it is determined that the second floor is dirtier than the first floor, for example. In such cases, a robotic vacuum cleaner configured with flight capabilities (e.g., the robotic vacuum cleaner 621) can fly to the second floor from the first floor. In another example, one of the robotic vacuum cleaners 620-623 can move onto an elevator, escalator, or other similar device, to be moved between floors.

It should be appreciated that, although the techniques described herein are described as relating to robotic vacuum cleaners, any suitable robotic device can utilize the present techniques, such as other types of robotic cleaners, which can clean a variety of surfaces, materials, objects, etc., including horizontal and vertical surfaces and spaces.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instruction by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments described herein.

What is claimed is:

1. A computer-implemented method for controlling a plurality of robotic cleaners, the method comprising:
receiving, by a processing system, data about a physical space to be cleaned by at least one of the plurality of robotic cleaners;
generating, by the processing system, a cleaning plan for the physical space based at least in part on the data about the physical space; and
dispatching, by the processing system, the at least one of the plurality of robotic cleaners within the physical space to clean the physical space based at least in part on the cleaning plan.

2. The computer-implemented method of claim 1, wherein the data about the physical space comprises inside data and outside data, the inside data relating to an area within the physical space, and the outside data relating to an area outside of the physical space.

3. The computer-implemented method of claim 1, wherein the physical space comprises a first level and a second level, and wherein dispatching the at least one of the plurality of robotic cleaners comprises dispatching a first subset of the plurality of robotic cleaners to the first level of the physical space and dispatching a second subset of the plurality of robotic cleaners to the second level of the physical space.

4. The computer-implemented method of claim 1, wherein the physical space comprises a first level and a second level, and wherein dispatching the at least one of the plurality of robotic cleaners comprises dispatching the at least one of the plurality of robotic cleaners to the first level of the physical space to clean the first level and subsequently dispatching the at least one of the plurality of robotic cleaners to the second level of the physical space to clean the second level.

5. The computer-implemented method of claim 4, wherein dispatching the at least one of the plurality of robotic cleaners to the second level comprises causing the at least one of the plurality of robotic cleaners to travel from the first level to the second level using an elevator.

6. The computer-implemented method of claim 4, wherein dispatching the at least one of the plurality of robotic cleaners to the second level comprises causing a flying drone to transport the at least one of the plurality of robotic cleaners from the first level to the second level.

7. The computer-implemented method of claim 1, further comprising dispatching the at least one of the plurality of robotic cleaners within the physical space as a scout robot to observe the physical space without cleaning the physical space.

8. The computer-implemented method of claim 7, wherein the scout robot operates in a scout mode responsive to being dispatched to observe the physical space, and wherein the scout robot operates in a cleaning mode responsive to being dispatched to clean the physical space.

9. The computer-implemented method of claim 1, wherein the at least one of the plurality of robotic cleaners is configured to communicate with at least one other of the plurality of robotic cleaners.

10. The computer-implemented method of claim 1, wherein the at least one of the plurality of robotic cleaners is configured to communicate with a robotic cleaner control system.

11. The computer-implemented method of claim 1, wherein at least one of the plurality of robotic cleaners is a robotic vacuum cleaner.

12. The computer-implemented method of claim 1, wherein the data about the physical space to be cleaned is collected by a sensor attached to a collar of an animal, and wherein the cleaning plan is based at least in part on the data collected by the sensor attached to the collar of the animal.

13. The computer-implemented method of claim 1, wherein one of the plurality of robotic cleaners is designated as a master robotic cleaner and another one of the plurality of robotic cleaners is designated as a slave robotic cleaner, the master robotic cleaner being in communication with and controlling the slave robotic cleaner.

14. The computer-implemented method of claim 1, wherein at least one of the plurality of robotic cleaners is configured as an internet of things (IoT) device.

15. The computer-implemented method of claim 1, wherein generating the cleaning plan for the physical space is based at least in part on user-defined preferences.

16. The computer-implemented method of claim 1, wherein the data about the physical space to be cleaned is received at least in part from a sensor associated with at least one of the plurality of robotic cleaners and received at least in part from a separate sensor not associated with at least one of the plurality of robotic cleaners.

17. A system comprising:
a memory comprising computer readable instructions; and
a processing device for executing the computer readable instructions for performing a method comprising:
receiving, by the processing system, data about a physical space to be cleaned by at least one of the plurality of robotic cleaners;
generating, by the processing system, a cleaning plan for the physical space based at least in part on the data about the physical space; and
dispatching, by the processing system, the at least one of the plurality of robotic cleaners within the physical space to clean the physical space based at least in part on the cleaning plan.

18. The system of claim 17, wherein the data about the physical space comprises inside data and outside data, the inside data relating to an area within the physical space, and the outside data relating to an area outside of the physical space.

19. The system of claim 17, wherein the physical space comprises a first level and a second level, and wherein dispatching the at least one of the plurality of robotic cleaners comprises dispatching a first subset of the plurality of robotic cleaners to the first level of the physical space and dispatching a second subset of the plurality of robotic cleaners to the second level of the physical space.

20. A computer program product comprising:
a computer readable storage medium having program instructions embodied therewith, the program instructions executable by a processing device to cause the processing device to perform a method comprising:
receiving, by the processing system, data about a physical space to be cleaned by at least one of the plurality of robotic cleaners;
generating, by the processing system, a cleaning plan for the physical space based at least in part on the data about the physical space; and
dispatching, by the processing system, the at least one of the plurality of robotic cleaners within the physical space to clean the physical space based at least in part on the cleaning plan.
